(19) United States
(12) Patent Application Publication
(10) Pub. No.: US 2011/0261404 A1
(43) Pub. Date: Oct. 27, 2011

(54) PRINTING CALIBRATION PROCESSING APPARATUS, IMAGE FORMING APPARATUS, PRINTING CALIBRATION PROCESSING METHOD, AND IMAGE FORMING METHOD

(75) Inventor: Hiroki Umezawa, Shizuoka-ken (JP)

(73) Assignees: TOSHIBA TEC KABUSHIKI KAISHA, Tokyo (JP); KABUSHIKI KAISHA TOSHIBA, Tokyo (JP)

(21) Appl. No.: 13/087,485

(22) Filed: Apr. 15, 2011

Related U.S. Application Data
(60) Provisional application No. 61/327,130, filed on Apr. 23, 2010.
(60) Provisional application No. 61/327,132, filed on Apr. 23, 2010.

(51) Int. Cl. G06K 15/02

(52) U.S. Cl. 358/1.15

(57) ABSTRACT

According to one embodiment, a printing calibration processing apparatus includes: a test-image output section configured to output plural patches for gradation characteristic generation to an image forming section as a test image; a gradation-characteristic-data generating section configured to read images on a printing surface and a rear surface of a test chart, which is obtained by the image forming section printing the test image on a print sheet, and generate gradation characteristic data of the printing surface and the rear surface; a gradation-correction-data creating section configured to determine a correction value of maximum gradation and create gradation correction data on the basis of gradation characteristics of the printing surface and gradation characteristics of the rear surface generated by the gradation-characteristic-data generating section; a gradation-correction-data storing section configured to store the gradation correction data created by the gradation-correction-data creating section; and a gradation correction section configured to subject image data output to the image forming section to gradation correction according to the gradation correction data stored by the gradation-correction-data storing section.

### CROSS-REFERENCE TO RELATED APPLICATION

This application is based upon and claims the benefit of priority from: U.S. provisional application 61/327,130, filed on Apr. 23, 2010; 61/327,132, filed on Apr. 23, 2010, the entire contents of all of which are incorporated herein by reference.

### FILED

Embodiments described herein relates generally to a technique for reducing so-called show-through in which ink shows through to make an image to be printed on a printing surface of a print sheet visible on the rear surface side opposite to the printing surface.

### BACKGROUND

In image forming apparatuses such as a printer and a MFP (Multi Function Peripheral), sheets having various characteristics such as recycled paper, a thick sheet, and a thin sheet can be used as printing media on which images such as characters are printed.

Depending on characteristics of a sheet in use, the density of a printed image, or the like, show-through in which a color material penetrating into the print sheet is visible from the rear surface side of the print sheet occurs. The show-through deteriorates the appearance on the rear surface side, for example, in simplex printing. In the simplex printing and duplex printing, since a blur of the color material is involved in the printing, in some case, deterioration in image quality on a printing surface is caused. In the duplex printing, in some case, it is difficult to read an image on the printing surface if the image overlaps a show-through image.

### DESCRIPTION OF THE DRAWINGS

FIG. 1 is a longitudinal sectional view of an image forming apparatus according to an embodiment;

FIG. 2 is a diagram of the configuration of an image processing system including the image forming apparatus shown in FIG. 1;

FIG. 3 is a diagram of an example of a hardware configuration of the image forming apparatus shown in FIG. 1;

FIG. 4 is a block diagram of a calibration processing section;

FIG. 5 is a flowchart for explaining the operation of the calibration processing section;

FIG. 6 is a diagram of a printed test chart;

FIG. 7A is a diagram of a read and printed front surface of the test chart;

FIG. 7B is a diagram of a read and printed rear surface of the test chart;

FIG. 8A is a graph of gradation characteristic data that requires gradation correction for show-through;

FIG. 8B is a graph of gradation correction data for reducing the show-through;

FIG. 9A, is a graph of gradation characteristic data that does not require the gradation correction for the show-through;

FIG. 9B is a graph of gradation correction data that does not require show-through reducing correction;

FIG. 10 is a flowchart for explaining processing for performing the gradation correction for the show-through and printing print data;

FIG. 11 is a flowchart for explaining a processing operation of the calibration processing section that deals with simplex and duplex printing in a second embodiment;

FIG. 12A is a graph of gradation characteristic data in the second embodiment;

FIG. 12B is a graph of gradation correction data for the simplex printing;

FIG. 12C is a graph of gradation correction data for the duplex printing; and

FIG. 13 is a flowchart for explaining processing for performing gradation correction for show-through and printing print data in the second embodiment.

### DETAILED DESCRIPTION

In general, according to one embodiment, a printing calibration processing apparatus includes: a test-image output section configured to output plural patches for gradation characteristic generation to an image forming section as a test image; a gradation-characteristic-data generating section configured to read images on a printing surface and a rear surface of a test chart, which is obtained by the image forming section printing the test image on a print sheet, and generate gradation characteristic data of the printing surface and the rear surface; a gradation-correction-data creating section configured to determine a correction value of maximum gradation and create gradation correction data on the basis of gradation characteristics of the printing surface and gradation characteristics of the rear surface generated by the gradation-characteristic-data generating section; a gradation-correction-data storing section configured to store the gradation correction data created by the gradation-correction-data creating section; and a gradation correction section configured to subject image data output to the image forming section to gradation correction according to the gradation correction data stored by the gradation-correction-data storing section.

In general, according to another embodiment, an image forming apparatus includes: an image reading section configured to read a document image; an image forming section configured to receive image data read by the image reading section and print an image on a print sheet; a test-image output section configured to output plural patches for gradation characteristic generation to the image forming section as a test image; a gradation-characteristic-data generating section configured to read, with the image reading section, images on a printing surface and a rear surface of a test chart, which is obtained by the image forming section printing the test image on a print sheet, and generate gradation characteristic data of the read printing surface and rear surface; a gradation-correction-data creating section configured to determine a correction value of maximum gradation and create gradation correction data on the basis of gradation characteristics of the printing surface and gradation characteristics of the rear surface generated by the gradation-characteristic-data generating section; a gradation-correction-data storing section configured to store the gradation correction data created by the gradation-correction-data creating section; and a gradation correction section configured to subject image data output to the image forming section to gradation correction according to the gradation correction data stored by the gradation-correction-data storing section.

In general, according to still another embodiment, a printing calibration processing method includes: outputting plural patches for gradation characteristic generation to an image forming section as a test image; reading images on a printing surface and a rear surface of a test chart, which is obtained by the image forming section printing the test image on a print sheet, and generating gradation characteristic data of the printing surface and the rear surface; determining a correction value of maximum gradation and creating gradation correction data on the basis of the generated gradation characteristics of the printing surface and gradation characteristics of the rear surface; storing the created gradation correction data in a gradation-correction-data storing section; and subjecting image data output to the image forming section to gradation correction according to the gradation correction data stored in the gradation-correction-data storing section.

In general, according to still another embodiment, an image forming method includes: receiving image data read by an image reading section and printing an image on a print sheet; outputting plural patches for gradation characteristic generation to an image forming section as a test image; reading images on a printing surface and a rear surface of a test chart, which is obtained by the image forming section printing the test image on a print sheet, and generating gradation characteristic data of the printing surface and the rear surface; determining a correction value of maximum gradation and creating gradation correction data on the basis of the generated gradation characteristics of the printing surface and gradation characteristics of the rear surface; storing the created gradation correction data in a gradation-correction-data storing section; and subjecting image data output to the image forming section to gradation correction according to the gradation correction data stored in the gradation-correction-data storing section.

Exemplary embodiments are explained in detail below with reference to the accompanying drawings.

### First Embodiment

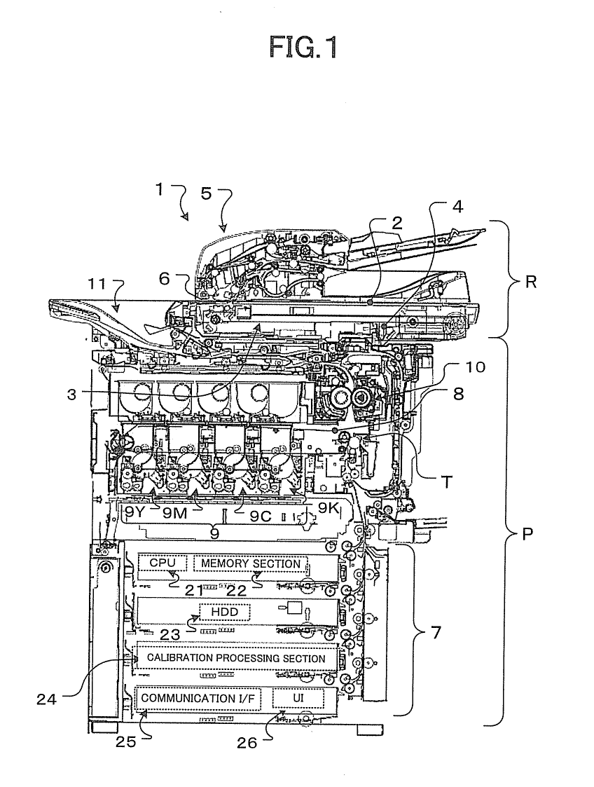

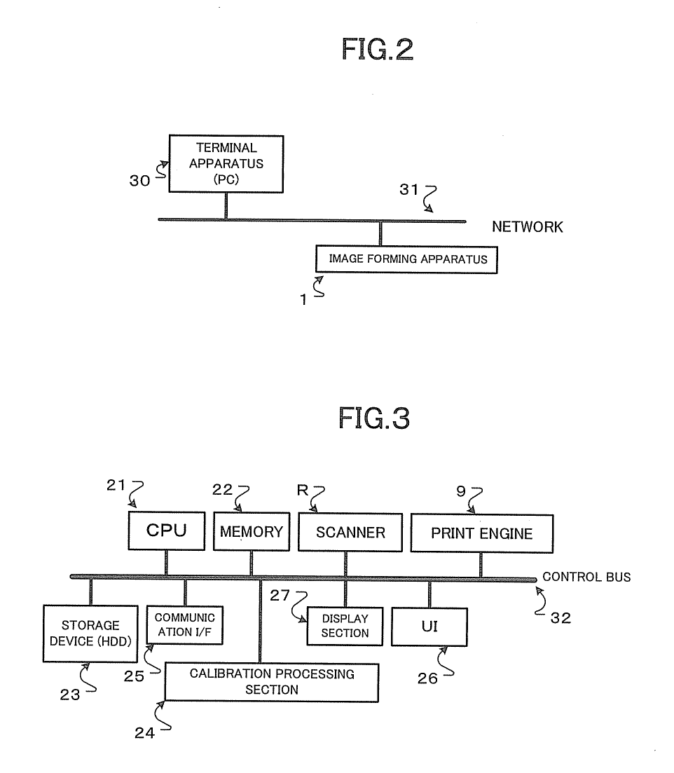

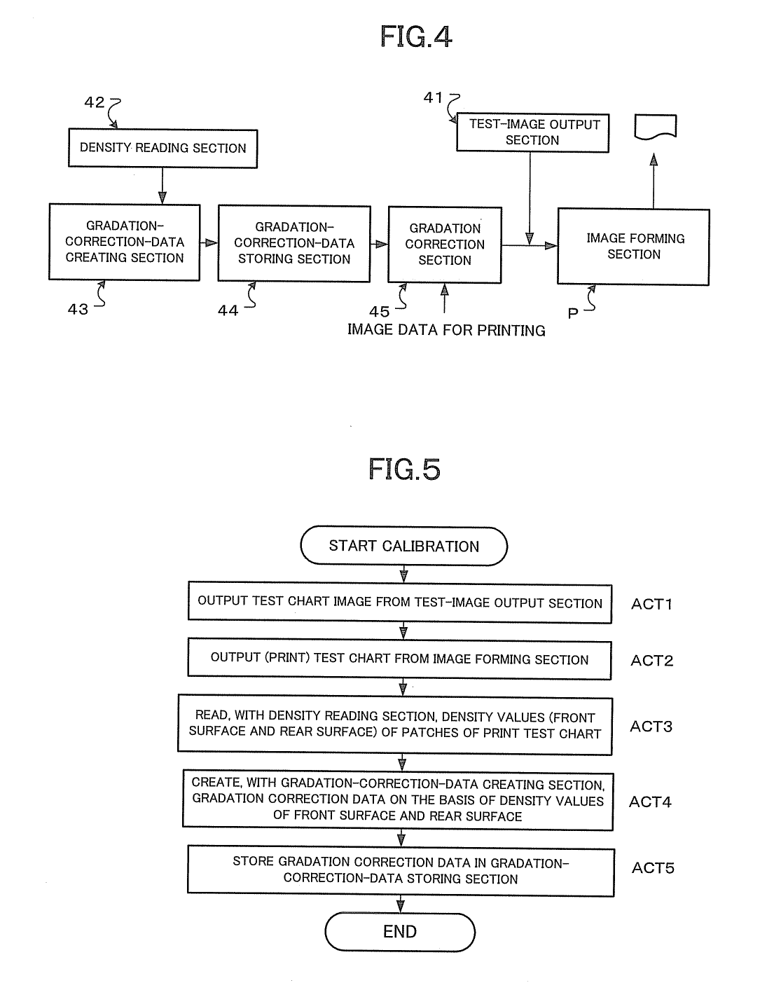

FIG. 1 is a diagram of the overall configuration of an image forming apparatus according to a first embodiment. A multi function peripheral (MFP) as an example of an image forming apparatus including a printer function, a copy function, and a document duplex reading function is shown in FIG. 1. FIG. 2 is a diagram of the configuration of an image processing system including the image forming apparatus shown in FIG. 1. FIG. 3 is a diagram of an example of a hardware configuration of the image forming apparatus shown in FIG. 1. FIG. 4 is a block diagram of a calibration processing section.

As shown in FIG. 1, an image forming apparatus 1 according to this embodiment includes an image reading section R and an image forming section P. As shown in FIG. 2, a terminal apparatus 30 such as a personal computer generates print data of a print job or the like and transmits the print data to the image forming apparatus 1 via a network 31. The image forming apparatus 1 receives the transmitted print data and outputs an image corresponding to the print data onto a print sheet.

The image reading section R has a function of scanning and reading images of a sheet document and a book document. In the image reading section R, a scanning optical system 3 and a light receiving section 4 configured to receive document reflected light guided by the scanning optical system 3 are arranged below a document table glass 2. In the image reading section R, an auto document feeder (ADF) 5 is openably and closably arranged above the document table glass 2 to automatically feed a document to a slit glass 6 for ADF arranged adjacent to the document table glass 2.

If a document placed on the document table glass 2 is read, when the document is placed on the document table glass 2 with a document surface faced down and a start button is pressed, reading of the document is started. When the reading of the document is started, the document is illuminated by the scanning optical system 3, which moves in a sub-scanning direction, reflected light of the document is guided to the light receiving section 4, and the document is read. Therefore, when the document is placed on the document table glass 2 with the document surface faced up and the reading of the document is performed, the rear surface side of the document is read.

The image forming section P has a function of forming a developer image on a sheet on the basis of, for example, an image read from a document by the image reading section R or image data transmitted from an external apparatus to the image forming apparatus 1. The image forming section P includes a paper feeding cassette section 7 including paper feeding cassettes in plural stages; an intermediate transfer belt 8, image forming process sections (print engine sections) 9 (9Y, 9M, 9C, and 9K) for yellow (Y), magenta (M), cyan (C), and black (K) including photoconductive drums and developing devices, a fixing device 10, and a discharge tray 11. The image forming section P includes an automatic duplex unit configured to, after one side of a sheet fed from the paper feeding cassettes is printed, reverse the sheet and guide the sheet to the image forming process sections 9 again.

The image forming apparatus 1 according to this embodiment includes a CPU (a control section) 21, a memory section 22, a hard disk section (a storage device) 23, a calibration processing section 24, a communication interface (I/F) 25, a user interface (UI) 26, and a display section 27.

The CPU 21 executes predetermined processing based on an image processing program stored in the memory section 22 or the storage device 23 and controls the operation of the image forming apparatus 1.

The memory section 22 can include, for example, a RAM (Random Access Memory), a ROM (Read Only Memory), a DRAM (Dynamic Random Access Memory), an SRAM (Static Random Access Memory), or a VRAM (Video RAM). The memory section 22 has a role of storing various kinds of information and computer program used in the image forming apparatus 1.

The image forming process sections 9 (9Y, 9M, 9C, and 9K) form electrostatic latent images on photoconductive surfaces of the photoconductive members for the respective colors for transferring developer images onto a sheet and develop and visualize, with the developing devices for the respective colors, the electrostatic latent images formed on the photoconductive surfaces of the photoconductive members. Developer images formed on the photoconductive members for the respective colors in this way are transferred onto the belt surface of the intermediate transfer belt 8 (so-called primary transfer). The developer images carried by the rotation of the intermediate transfer belt 8 are transferred onto a conveyed sheet in a predetermined secondary transfer position T.

The fixing device 10 heats and fixes the developer images, which are transferred onto the sheet, on the sheet. Sheets having the developer images heated and fixed thereon are conveyed through a conveying path by plural conveying roller pairs and sequentially output onto the discharge tray 11.

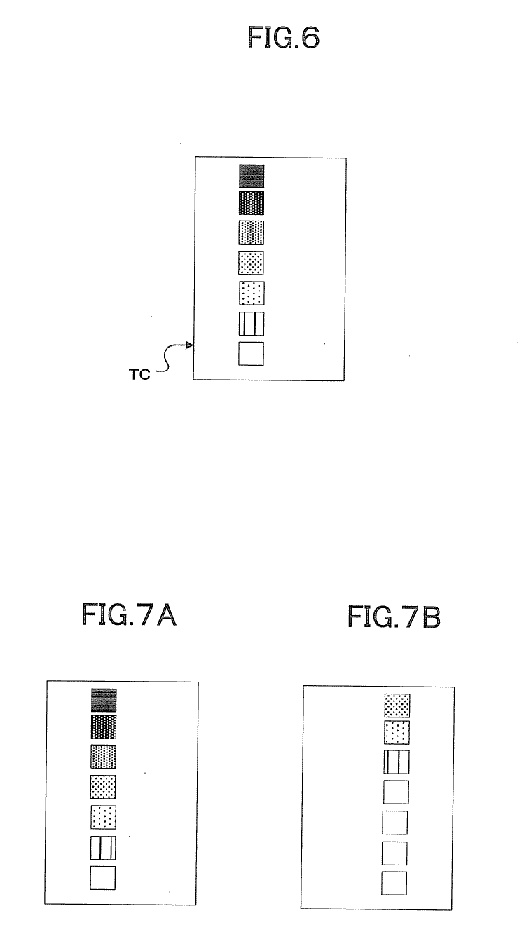

FIG. 4 is a block diagram of the calibration processing section 24. The calibration processing section 24 starts operation when a selection switch of the display section 27 is operated to select a calibration operation. The calibration processing section 24 includes a test-image output section 41 for forming a test image on sheets in the paper feeding cassettes in which sheets to be subjected to show-through prevention are stacked. The calibration processing section 24 outputs the test image from the test-image output section 41 to the image forming section P. FIG. 6 is a diagram of a test chart TC obtained by printing the test image on a sheet to be subjected to show-through prevention. In the test chart TC shown in FIG. 6, plural patches having different densities are formed in order from a patch having lowest density to a patch having highest density along the sub-scanning direction.

The calibration processing section 24 includes a density reading section 42 configured to read the density of the test chart TC. In this embodiment, the image reading section R is used as the density reading section 42. Specifically, the calibration processing section 24 reads image densities of both the front and rear surfaces of the test chart TC and calculates density values of the patches on the front and rear surfaces by performing front-surface reading processing for placing the sheet on the document table glass 2 with a printing surface of the test chart TC faced down and reading the printing surface and rear-surface reading processing for placing the sheet on the document table glass 2 with the printing surface of the test chart TC faced up and reading the rear side opposite to the printing surface. The calibration processing section 24 performs, on the basis of a reading result of the density reading section 42, creation of gradation correction data for reducing show-through with a gradation-correction-data creating section 43.

FIG. 7A is a diagram of a printing result of the printing surface of the test chart TC read by the density reading section 42. FIG. 7B is a diagram of a printing result of the rear surface of the test chart TC read by the density reading section 42.

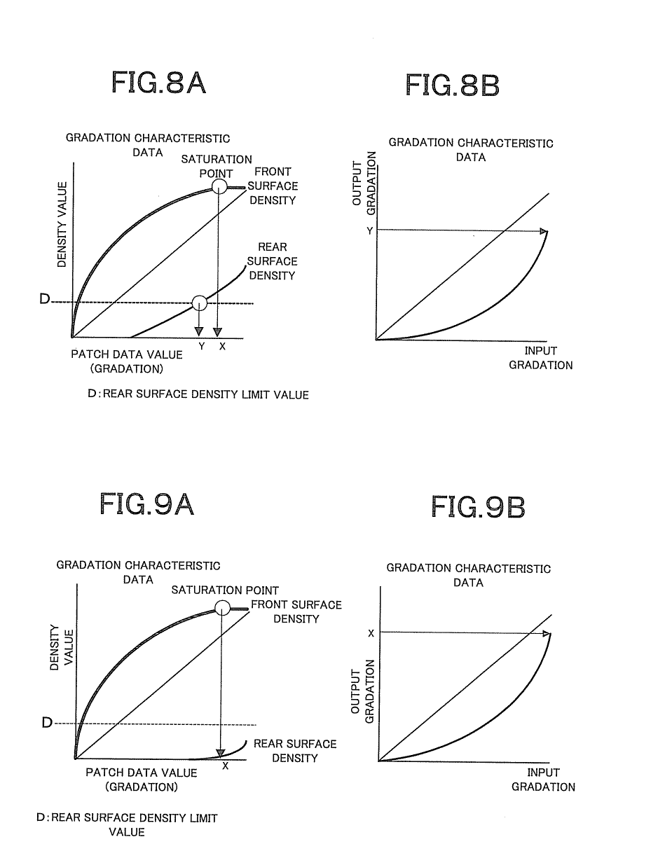

An example of the density values of both the front and rear surfaces calculated by the density reading section 42 is shown in FIG. 8A. In FIG. 8A, the abscissa indicates a patch data value (gradation) and the ordinate indicates a density value. A linear characteristic line having a tilt of 45 degrees indicates a target gradation characteristic line. As the density of the front surface of the test chart TC shown in FIG. 6, the density value is output higher than the target gradation characteristic line from low gradation to high gradation and is saturated at an X point before the maximum gradation.

On the other hand, concerning the rear surface density, as shown in FIG. 7B, show-through does not occur from the low gradation to intermediate gradation and occurs from the intermediate gradation to the high gradation.

The gradation-correction-data creating section 43 calculates, in rear surface density gradation characteristic data, a patch data value Y corresponding to a density limit value D set in advance at which show-through can be allowed. The rear surface density is present exceeding the patch data value Y. Show-through having density higher than the allowable density is present. The saturation point X of the front surface density of the printing surface is larger than the patch data value Y of the rear surface. In other words, if a density value of the front surface is determined not to exceed the rear surface patch data value Y, show-through in a selected sheet can be reduced. Concerning the intermediate gradation, a characteristic line opposite to the gradation characteristic line of the front surface density across the target gradation characteristic line is set as gradation correction data. FIG. 8E is a graph of a characteristic line of the gradation correction data.

For example, the gradation correction data shown in FIG. 8B created by the gradation-correction-data creating section 43 is stored in a gradation-correction-data storing section 44. During actual print, the gradation correction data is transmitted to a gradation correction section 45 to correct image data for printing and output to the image forming section P.

FIG. 8A is a graph of gradation correction data at the time when unallowable show-through occurs. If the density of the rear surface does not exceed a rear surface density limit value D set in advance as shown in FIG. 9A, since Y (Y is substantially infinite)>X, as shown in FIG. 9B, gradation correction data is created such that a patch data value (gradation) at the saturation point X of the surface density is a maximum of the gradation correction data.

In FIGS. 8A and 9A, the rear surface density limit value D is a fixed value. However, the rear surface density limit value D may be adjustable.

FIG. 5 is a flowchart for explaining a processing operation of the calibration processing section 24. When calibration is started, the calibration processing section 24 outputs a test chart image from the test-image output section 41 (ACT 1) and outputs (prints) a test chart from the image forming section P (ACT 2). Thereafter, the calibration processing section 24 reads, with the density reading section 42, concerning the front surface and the rear surface, density values of patches of the test chart subjected to simplex printing (ACT 3). The calibration processing section 24 creates, with the gradation-correction-data creating section 43, gradation correction data on the basis of the density values of the front surface and the rear surface read in ACT 3 (ACT 4) and stores the gradation correction data in the gradation-correction-data storing section 44 (ACT 5).

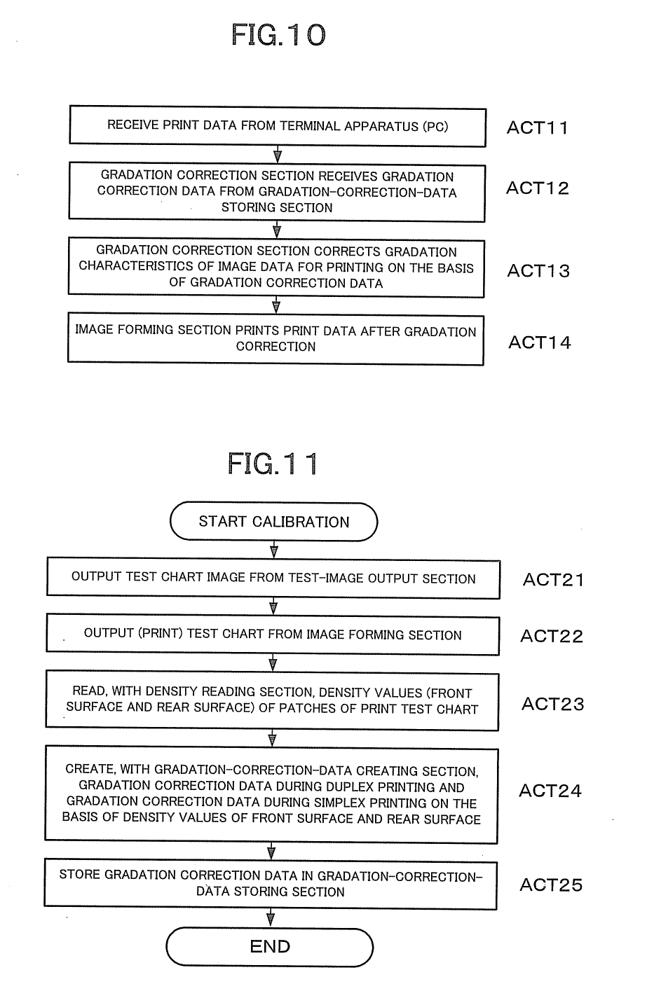

Subsequently, after the calibration processing ends in the calibration processing section 24, print data from the personal computer 30 is transmitted to the image forming apparatus 1. Then, printing with show-through reduced is performed according to a flowchart shown in FIG. 10.

In FIG. 10, the image forming apparatus 1 receives the print data from the personal computer 30 (ACT 11). First, the gradation correction section 45 receives the gradation correction data stored in the gradation-correction-data storing section 44 (ACT 12). The gradation correction section 45 corrects gradation characteristics of the image data for printing on the basis of the gradation correction data (ACT 13). Thereafter, the image forming section P performs printing according to the image data for printing after the gradation correction (ACT 14). Therefore, show-through is reduced on a printed sheet.

In this embodiment, the density values of the test chart are read and the gradation correction with show-through reduced is performed. However, gradation correction data may be created according to brightness using a read L* value of CIELAB.

### Second Embodiment

In the first embodiment, the processing by the calibration processing section 24 for reducing show-through during the simplex printing is explained. In a second embodiment, processing for reducing show-through during both the simplex printing and the duplex printing is explained.

The calibration processing section 24 shown in FIG. 4 outputs, when calibration is started, a test chart image from the test-image output section 41 (ACT 21) and outputs (prints) a test chart from the image forming section P (ACT 22) Thereafter, The calibration processing section 24 reads, with the density reading section 42, concerning the front surface and the rear surface, density values of patches of the test chart subjected to simplex printing (ACT 23). The calibration processing section 24 creates, with the gradation-correction-data creating section 43, gradation correction data on the basis of the density values of the front surface and the rear surface read in ACT 23 (ACT 24) and stores the gradation correction data in the gradation-correction-data storing section 44 (ACT 25).

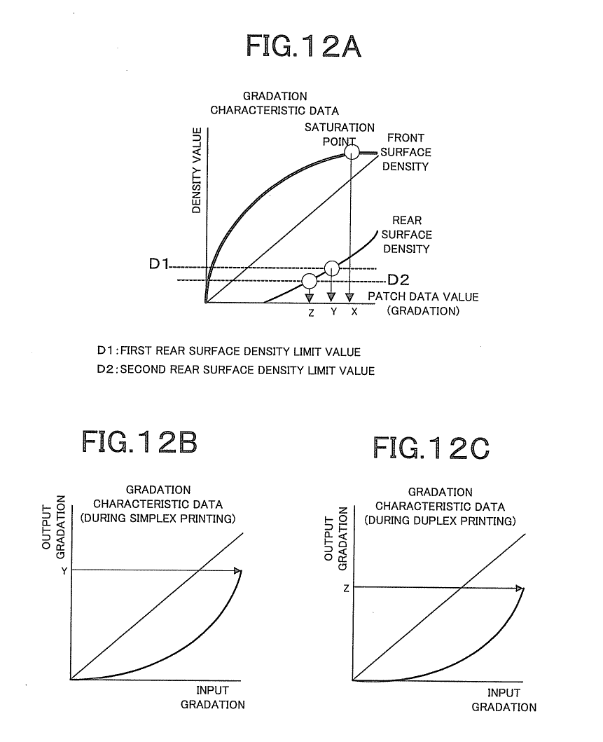

The density reading section 42 calculates density values of the front surface and the rear surface of patches of the read test chart. For example, a result of the calculation is represented as a graph of gradation characteristic data shown in FIG. 12A. As it is seen from the figure, both gradation characteristics of front surface density and rear surface density are shown on the graph.

It is assumed that the density values of the front surface and the rear surface of the patches of the test chart read by the density reading section 42 have, for example, gradation characteristics shown in FIG. 12A. The front surface density is saturated at a point X of a patch data value (gradation). The rear surface density exceeds, at a point Y, a first rear surface density limit value (for simplex printing) D1 determined in advance. The rear surface density exceeds, at a point Z, a second rear surface density limit value (for duplex printing) D2 determined in advance. In such a case, as in FIG. 8A, since Y<X, gradation correction data for simplex printing is created such that a patch data value (gradation) of Y shown in FIG. 12B is a maximum of the gradation correction data. The gradation correction data for simplex printing is created such that an intermediate value of the gradation correction data is symmetrical to target gradation characteristics. The first rear surface density limit value (for simplex printing) D1 and the second rear surface density limit value (for duplex printing) D2 may be adjustable.

Since Z<X, as shown in FIG. 12C, gradation correction data for duplex printing is created such that a patch data value (gradation) of Z is a maximum of the gradation correction data. The gradation correction data for duplex printing is created such that an intermediate value of the gradation correction data is symmetrical to target gradation characteristics.

Consequently, according to the second embodiment, during the simplex printing and during the duplex printing, gradation correction data not exceeding limit densities of the rear surface in the simplex printing and the duplex printing can be created. Calibration that resolves the problem of poor visibility due to show-through during the duplex printing can be realized.

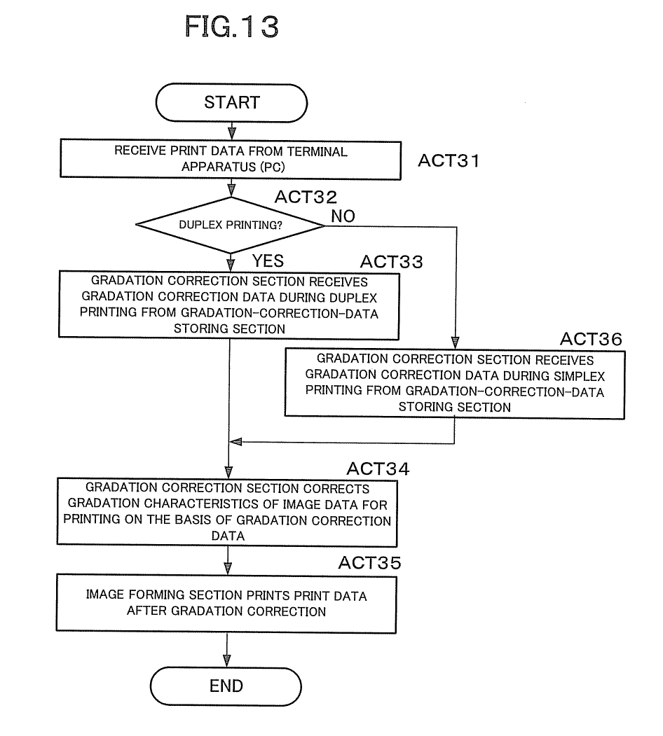

FIG. 13 is a flowchart for explaining processing for printing print data from the personal computer 30 in the second embodiment.

The image forming apparatus 1 receives image data for printing from the personal computer 30 (ACT 31). Subsequently, the image forming apparatus 1 determines whether designation of a printing mode is duplex or simplex (ACT 32). If the duplex printing is designated, the gradation correction section 45 receives gradation correction data during duplex printing from the gradation-correction-data storing section 44 (ACT 33). If the simplex printing is designated, the gradation correction section 45 receives gradation correction data during simplex printing from the gradation-correction-data storing section 44 (ACT 36). The gradation correction section 45 corrects image data for printing on the basis of the gradation correction data (ACT 34). Thereafter, the image forming section P prints the image data for printing after the gradation correction (ACT 35).

In the above explanation, the density values are used. However, the gradation correction data for simplex printing and the gradation correction data for duplex printing may be created according to brightness using a read L* value of CIELAB.

According to the second embodiment, it is possible to provide calibration that resolves the problem of poor visibility due to show-through during the duplex printing.

In the embodiments, the patches are formed in monochrome. However, the patches may be formed in a chromatic color.

In the example of the processing explained with reference to FIG. 4, the CPU 21 for internal data processing is caused to execute a computer program stored in advance in a storage area provided in the image forming apparatus 1. However, the computer program may be downloaded from a network to the MFP 1. The computer program stored in a computer-readable recording medium may be installed in the MFP 1. The storage medium may be any storage medium as long as the storage medium can store the computer program and is computer-readable. As the storage medium, for example, a RAM (Random Access Memory), a ROM (Read Only Memory), a DRAM, an SRAM (Static Random Access Memory), a VRAM (Video RAM), or a flash memory can be used.

The present invention can be carried out in other various forms without departing from the spirit and the main characteristics of the present invention. Therefore, the embodiments are merely examples in every aspect and should not be limitedly interpreted. The scope of the present invention is indicated by the scope of claims and is by no means limited by the text of the specification. All modifications and various improvements, substitutions, and alterations belonging to the scope of equivalents of the scope of claims are within the scope of the present invention.

What is claimed is:

1. A printing calibration processing apparatus comprising:
a test-image output section configured to output plural patches for gradation characteristic generation to an image forming section as a test image;
a gradation-characteristic-data generating section configured to read images on a printing surface and a rear surface of a test chart, which is obtained by the image forming section printing the test image on a print sheet, and generate gradation characteristic data of the printing surface and the rear surface;
a gradation-correction-data creating section configured to determine a correction value of maximum gradation and create gradation correction data on the basis of the gradation characteristics of the printing surface and the gradation characteristics of the rear surface generated by the gradation-characteristic-data generating section;
a gradation-correction-data storing section configured to store the gradation correction data created by the gradation-correction-data creating section; and
a gradation correction section configured to subject image data output to the image forming section to gradation correction according to the gradation correction data stored by the gradation-correction-data storing section.

2. The apparatus according to claim 1, wherein the plural patches for gradation characteristic generation include plural patches having different densities.

3. The apparatus according to claim 2, wherein the gradation-correction-data creating section creates gradation correction data for setting, as maximum gradation, gradation corresponding to a limit value of rear surface density to be set with respect to rear surface gradation characteristic data.

4. The apparatus according to claim 2, wherein the gradation-correction-data creating section sets limit values of two rear surface densities having different density values with respect to rear surface gradation characteristic data and creates gradation correction data for simplex printing for setting, as maximum gradation for simplex printing, gradation corresponding to a first rear surface density limit value having a high density value and gradation correction data for duplex printing for setting, as maximum gradation for duplex printing, gradation corresponding to a second rear surface density limit value having a low density value.

5. An image forming apparatus comprising:
an image reading section configured to read a document image;
an image forming section configured to receive image data read by the image reading section and print an image on a print sheet;
a test-image output section configured to output plural patches for gradation characteristic generation to the image forming section as a test image;
a gradation-characteristic-data generating section configured to read, with the image reading section, images on a printing surface and a rear surface of a test chart, which is obtained by the image forming section printing the test image on a print sheet, and generate gradation characteristic data of the read printing surface and rear surface;
a gradation-correction-data creating section configured to determine a correction value of maximum gradation and create gradation correction data on the basis of the gradation characteristics of the printing surface and the gradation characteristics of the rear surface generated by the gradation-characteristic-data generating section;
a gradation-correction-data storing section configured to store the gradation correction data created by the gradation-correction-data creating section; and
a gradation correction section configured to subject image data output to the image forming section to gradation correction according to the gradation correction data stored by the gradation-correction-data storing section.

6. The apparatus according to claim 5, wherein the plural patches for gradation characteristic generation include plural patches having different densities.

7. The apparatus according to claim 6, wherein the gradation-correction-data creating section creates gradation correction data for setting, as maximum gradation, gradation corresponding to a limit value of rear surface density to be set with respect to rear surface gradation characteristic data.

8. The apparatus according to claim 6, wherein the gradation-correction-data creating section sets limit values of two rear surface densities having different density values with respect to rear surface gradation characteristic data and creates gradation correction data for simplex printing for setting, as maximum gradation for simplex printing, gradation corresponding to a first rear surface density limit value having a high density value and gradation correction data for duplex printing for setting, as maximum gradation for duplex printing, gradation corresponding to a second rear surface density limit value having a low density value.

9. A printing calibration processing method comprising:
outputting plural patches for gradation characteristic generation to an image forming section as a test image;
reading images on a printing surface and a rear surface of a test chart, which is obtained by the image forming section printing the test image on a print sheet, and generating gradation characteristic data of the printing surface and the rear surface;
determining a correction value of maximum gradation and creating gradation correction data on the basis of the generated gradation characteristics of the printing surface and gradation characteristics of the rear surface;
storing the created gradation correction data in a gradation-correction-data storing section; and
subjecting image data output to the image forming section to gradation correction according to the gradation correction data stored in the gradation-correction-data storing section.

10. The method according to claim 9, wherein the plural patches for gradation characteristic generation include plural patches having different densities.

11. The method according to claim 10, wherein gradation correction data sets, as maximum gradation, gradation corresponding to a limit value of rear surface density to be set with respect to rear surface gradation characteristic data.

12. The method according to claim 10, wherein the gradation correction data sets limit values of two rear surface densities having different density values with respect to rear surface gradation characteristic data and is gradation correction data for simplex printing for setting, as maximum gradation for simplex printing, gradation corresponding to a first rear surface density limit value having a high density value and gradation correction data for duplex printing for setting, as maximum gradation for duplex printing, gradation corresponding to a second rear surface density limit value having a low density value.

13. An image forming method comprising:
receiving image data read by an image reading section and printing an image on a print sheet;
outputting plural patches for gradation characteristic generation to an image forming section as a test image;
reading images on a printing surface and a rear surface of a test chart, which is obtained by the image forming section printing the test image on a print sheet, and generating gradation characteristic data of the printing surface and the rear surface;
determining a correction value of maximum gradation and creating gradation correction data on the basis of the generated gradation characteristics of the printing surface and gradation characteristics of the rear surface;
storing the created gradation correction data in a gradation-correction-data storing section; and
subjecting image data output to the image forming section to gradation correction according to the gradation correction data stored in the gradation-correction-data storing section.

14. The method according to claim 13, wherein the plural patches for gradation characteristic generation include plural patches having different densities.

15. The method according to claim 14, wherein gradation correction data sets, as maximum gradation, gradation corresponding to a limit value of rear surface density to be set with respect to rear surface gradation characteristic data.

16. The method according to claim 14, wherein the gradation correction data sets limit values of two rear surface densities having different density values with respect to rear surface gradation characteristic data and is gradation correction data for simplex printing for setting, as maximum gradation for simplex printing, gradation corresponding to a first rear surface density limit value having a high density value and gradation correction data for duplex printing for setting, as maximum gradation for duplex printing, gradation corresponding to a second rear surface density limit value having a low density value.
